(19) United States
(12) Patent Application Publication
(10) Pub. No.: US 2006/0253871 A1
(43) Pub. Date: Nov. 9, 2006

(54) Video-on-demand system and related managing method

(75) Inventor: Umberto Berti, Rome (IT)

Correspondence Address: OHLANDT, GREELEY, RUGGIERO & PERLE, LLP, ONE LANDMARK SQUARE, 10TH FLOOR, STAMFORD, CT, 06901, US

(73) Assignee: GE Gesitone Sistemi S.r.I

(21) Appl. No.: 10/543,227

(22) PCT Filed: Jul. 14, 2003
(86) PCT No.: PCT/IT03/00438

§ 371 Date: May 2, 2006

(30) Foreign Application Priority Data
Jan. 22, 2003 (IT) RM2003A000023

(51) Int. Cl. H04N 7/173; H04N 5/445; G06F 13/00; G06F 3/00

(52) U.S. Cl. 725/61; 725/87; 725/104

(57) ABSTRACT

A video-on-demand system of the type comprising a plurality of local user-units in communication with a central distribution unit apt to transmit to each local user-unit a video selected by the latter unit from a menu stored at local level, wherein each local user-unit comprises local unit for updating the menu, apt to process a menu-verification require for the central distribution unit.

The present invention relates to a video-on-demand system and a related managing method. In particular, it relates to a system of the type comprising a plurality of local user-units and to a central distribution unit apt to transmit to each local user-unit a video selected from a menu.

Several so-called “video-on-demand” systems are known, wherein a central distribution unit transmits—upon request—to each local user-unit of a plurality of local units subscribed to the service videos, such as for example movies, television programmers such as sporting events and topical programs and so on.

Although systems of this type are becoming more and more widespread, they are not wholly satisfactory in terms of efficiency and simplicity in managing the information transmission from the central distribution unit to the local user-units and vice versa. The technical problem underlying the present invention is thus to provide a video-on-demand system and a related managing method allowing to obviate to the drawbacks mentioned above by referring to the known art.

Such problem is solved by a system according to claim 1.

According to the same inventive concept, the present invention further relates to a method according to claim 16.

Preferred features of the present invention are present in the depending claims of the same.

The present invention provides some important advantages. One of the main advantages is that the illustrated system and method allow an efficient updating of the menu of the videos available on the central distribution unit, which menu is stored at the level of each local user-unit.

Other advantages, features and application modes of the present invention will be evident by the following detailed description of some embodiments, shown by way of example and not for limitative purposes. The figures of the enclosed drawings will be referred to, wherein:

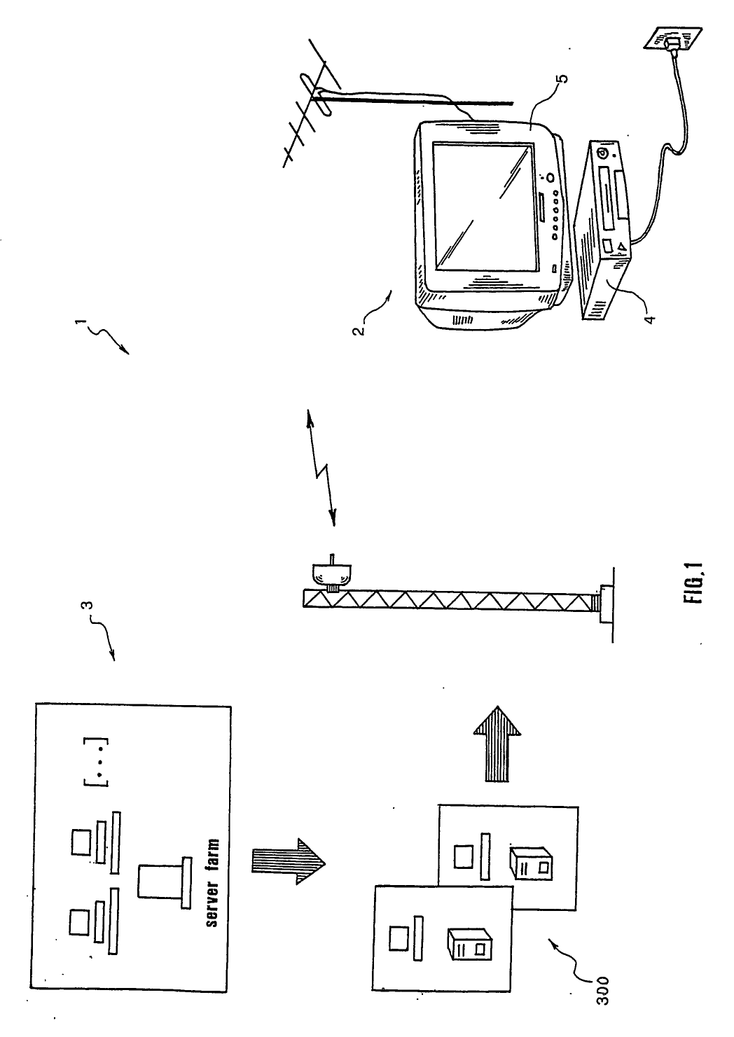

FIG. 1 shows a schematic representation of a first embodiment of a video-on-demand system according to the present invention;

FIG. 1A shows a schematic representation of an embodiment variant of the video-on-demand system of FIG. 1;

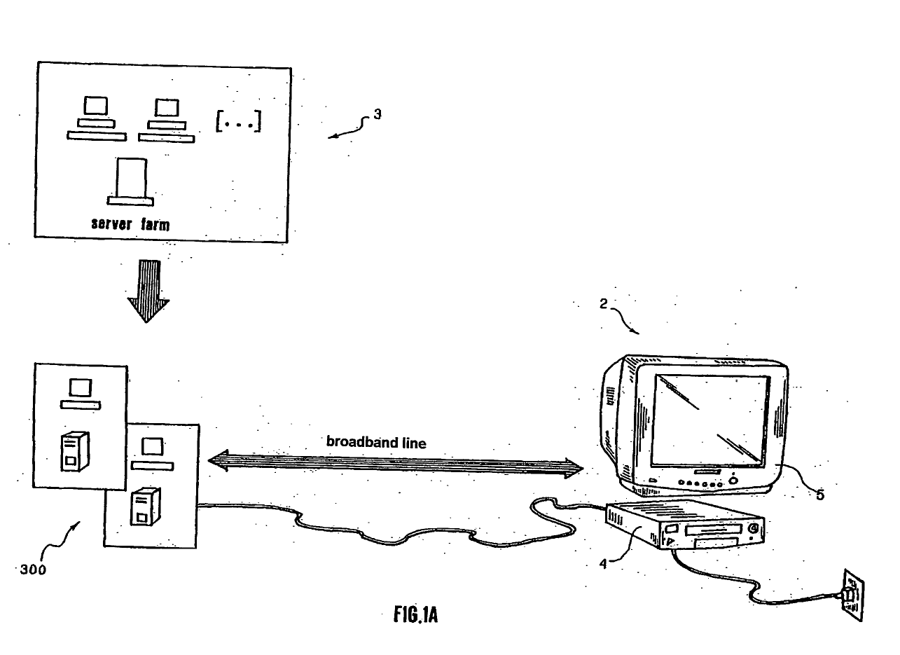

FIG. 2 shows a schematic representation of another embodiment of a video-on-demand system according to the present invention;

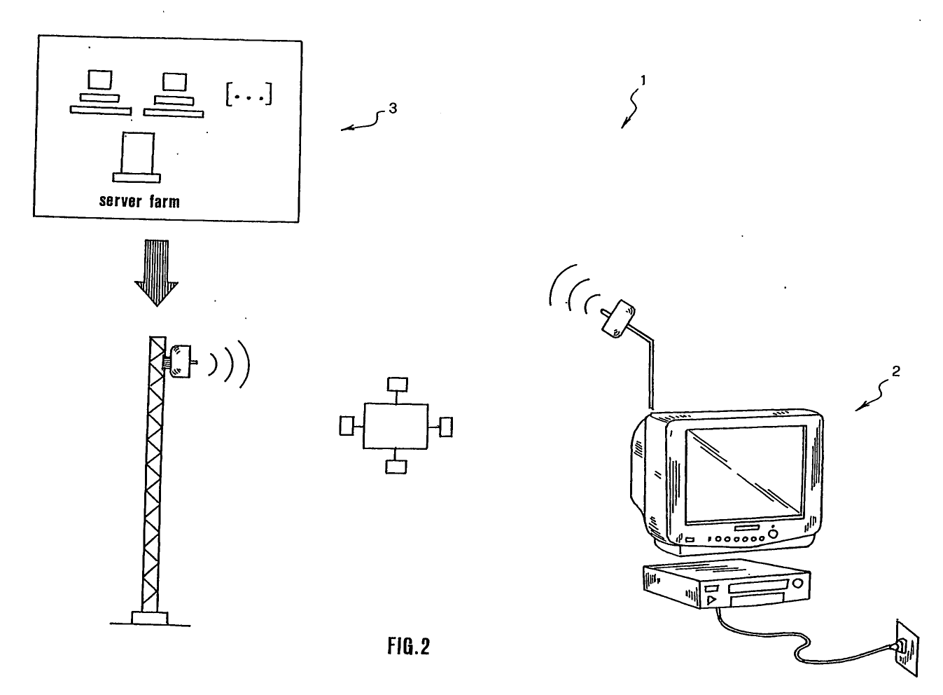

FIG. 3 shows a block diagram of a central distribution unit of the system of FIG. 1 or 2;

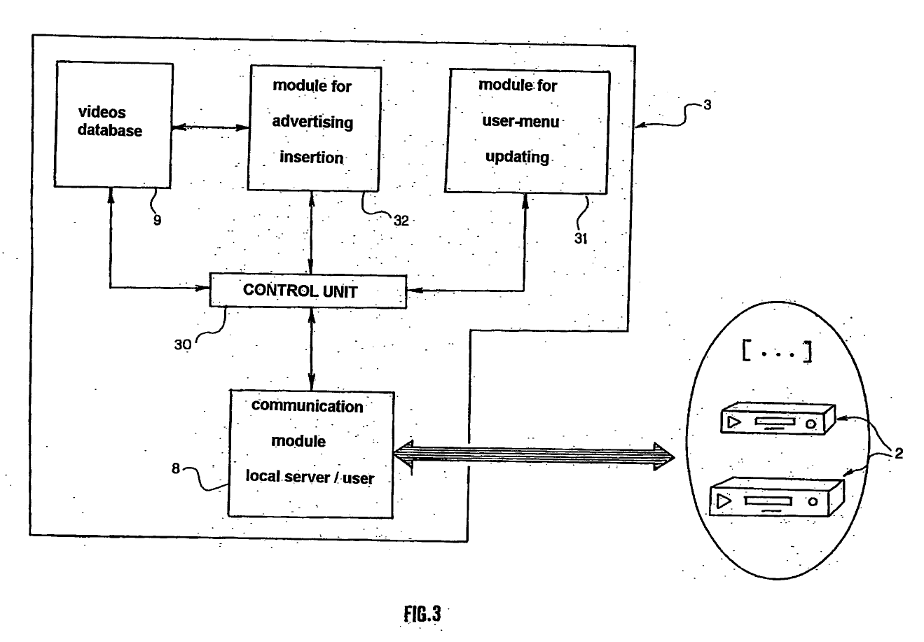

FIG. 4 shows a block diagram of a local user-unit of the system of FIG. 1 or 2;

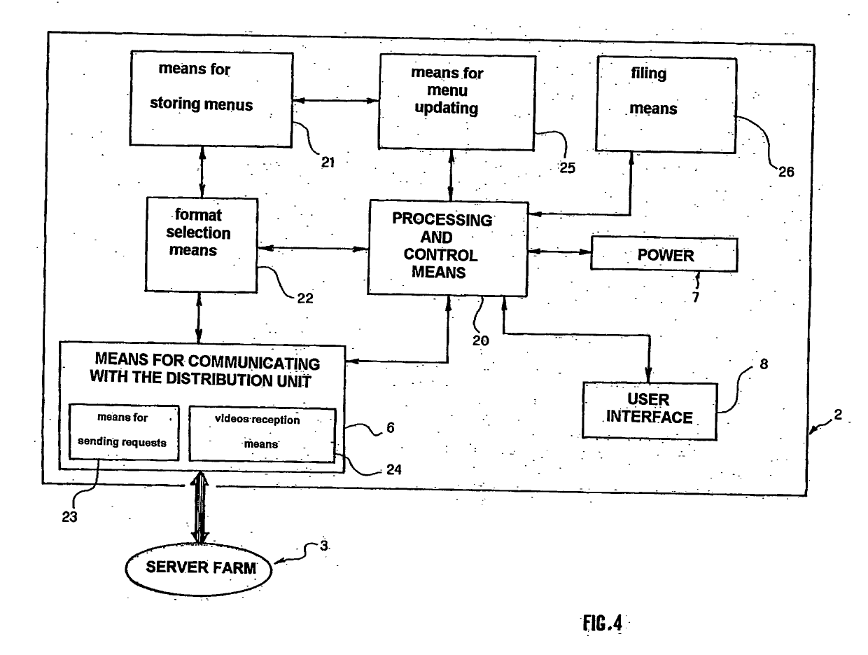

FIG. 5 shows a diagram of a procedure for initializing a local user-unit of the system of FIG. 1 or 2; and

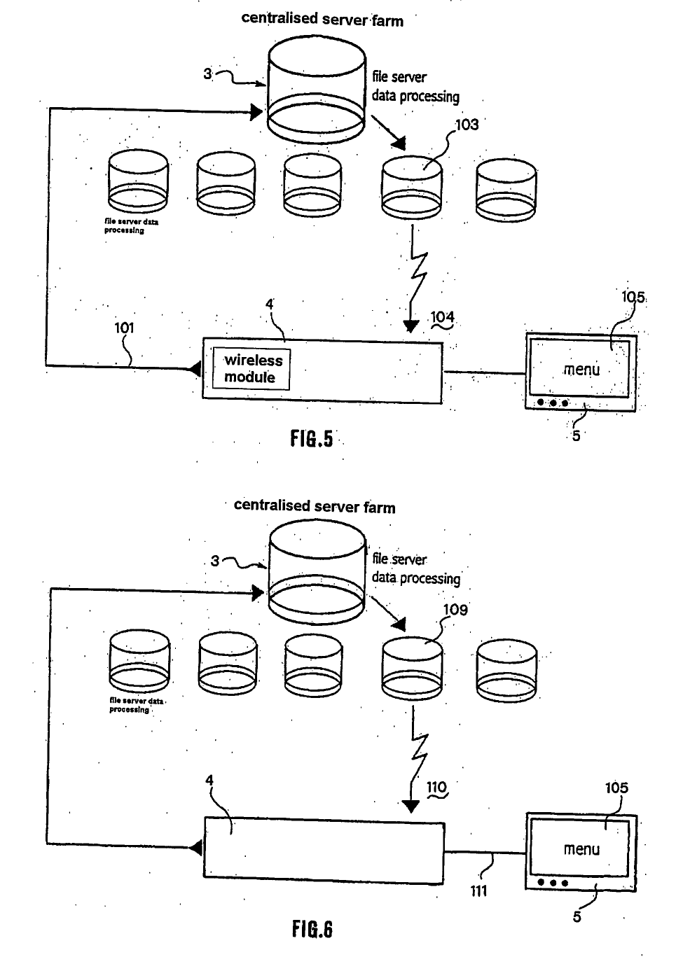

FIG. 6 shows a diagram of a procedure for requesting a video of a local user-unit of the system of FIG. 1 or 2.

By firstly referring to the FIG. 1, a video-on-demand system is designated as a whole with 1. The system comprises a plurality of local user-units 2 and a central distribution unit 3 apt to transmit videos to each local user-unit 2 upon a specific request of the latter.

Each local user-unit 2 comprises a decoder 4 apt to receive and transmit data from/to the distribution unit 3 and associated with a video display device 5, typically a television set.

The components and functions of each local unit 2 implemented by means of the decoder 4 will be now described in detail by referring also to FIG. 4.

Each local user-unit 2 first of all comprises:
processing and control means 20, apt indeed to control and interconnect all the other components of the unit 2;
means 21 for storing a video menu;
means 22 apt to allow the user to select a video from the menu mentioned above; and
means 6 for communicating with the distribution unit 3.

The video menu stored at local level can be split into two parts, and in particular into a frequent-updating menu, which could be called “dynamic” menu, related to the current events, for example to the last ten days of television programming of all the national broadcasting stations (news, talk shows, weather, sport and so on), and into an occasional-updating menu, which could be called “static” menu, related instead to movies, file documents, musical excerpts, sporting events and so on.

The means 6 for communicating with the distribution unit 3, in turn, comprises means 23 for sending a transmission request of the selected video to the central distribution unit 3 and means 24 for receiving the requested video. In the present embodiment, the means 23 are implemented by means of a wireless module of the GSM, GPRS, UMTS type comprising a SIM card.

Embodiment variants can provide that a video transmission request be sent by means of a modem of other type. For example, in the embodiment of FIG. 2 such request is vehiculated by Internet.

Still in the present embodiment, the reception means 24, instead, is implemented by means for receiving a satellite signal.

Of course, embodiment variants can also provide that the video request and reception take place by means of a single hardware system and specific dedicated software. By coming back now to the embodiment of FIG. 1, each local unit 2 then comprises, according to the invention, local means 25 for updating the locally stored menu. Such means 25 is apt to work out and send a menu-verification request to the central distribution unit 3, which request is in the form of a data string containing an identifier of the menu version stored indeed at local level. In the present embodiment, such menu-verification request is sent by means of the communication means 6, and in particular by means of the wireless module of the means 23 mentioned above.

The means 25 allows a menu updating according to the following procedure.

First of all, the means 25 analyzes the files on board the decoder 4, previously filed on a hard disk or rigid memory of the processing and control unit 20, representing the file list, the quantity of the occupied memory and the quantity of the available memory.

Thus, said means 25 provides for the creation of a numeric string containing a first portion which contains an identifier of the menu version stored at the level of the specific local unit 2 and a second portion which contains an identifier of the local user-unit 2 itself.

In particular, the string worked out in the present embodiment includes:
(a) an identifier of the decoder 4, in particular the serial number thereof;
(b) an identifier of the firmware residing in the local unit 2, in particular the serial number thereof;,
(c) an identifier of the version of the programs' menu present in the local memory, that is in the means 21, possibly split into an identifier of the static menu mentioned above and into an identifier of the dynamic menu mentioned above;
(d) an identifier of the SIM card of the means 23 for sending requests, in particular the serial number thereof; and
(e) an identifier of the related telephone use.

Preferably, the updating means 25 is configured so that the verification request be sent automatically upon each activation of the decoder 4, so as to communicate to the central distribution unit 3 all the data related to its own status in the terms specified above.

As shown still in FIG. 4, in the present embodiment each local unit 2 further comprises means 26 for storing and filing the videos received by means of said communication means 6.

Each local unit 2 then comprises a power supply 7, typically associated with the local supply mains, and a user interface 8 implementable in a known way.

The central distribution unit 3 will be now described in greater detail by referring to the FIGS. 1 and 3. First of all, such unit 3, which is typically a television provider, can be easily implemented as a server farm, possibly supported by territorial servers 300.

The distribution unit 3 first of all comprises a control unit 30 apt indeed to the control and to the interconnection of all the other components of the unit 3 itself. The unit 3 then comprises a central communication module 8, apt to receive the requests of the local user-units 2 and to transmit thereto the requested videos. To this purpose, such module 8 is apt to interface itself with the local communication means 6 introduced above. The whole arrangement of the module 8 itself and of the local communication means 6 is such to allow a video transmission in the streaming mode by means of a satellite signal.

The distribution unit 3 then comprises, according to the invention, means 31 for updating the local menus, apt to send to each local user-unit 2, in reply to the menu-verification request, data for updating the local menu. Such means 31 acts according to the following procedure. The means 31 analyzes the numeric string forwarded by a certain local unit 2, it compares the menu version identified in the string itself with the latest available version and, in case such comparison points out a difference, it sends to the local unit 2 the most recent version of the menu—and in particular of the dynamic part and of the static part thereof introduced above. In the present embodiment, the data for updating the menu are released in a text format which the local unit 2 re-processes by means of the residing firmware.

The local unit 2 can then make to appear the menus updated and assembled graphically as indeed provided by the last version released by the distribution unit 3. This allows the end user, who is typically a tele-viewer, to have always updated menus with the availability of all the latest programs.

The sending of the updating data mentioned above can take place on the wireless module of the communication means 6 of the local unit 2 or in some other way.

Of course, the distribution unit 3 then comprises a database of videos 9.

In the present embodiment, the distribution unit 3 further comprises means 32 to insert advertising in a video to be transmitted to a local user-unit 2.

Both the local units 2 and the central unit 3 can be implemented by means of hardware and/or software means of known type for a person skilled in the art and therefore we will not further dwell upon their description.

The invention further provides a managing method of a video-on-demand system of the type described sofar, which method comprises a procedure for updating the menu of each local user-unit 2 which, in turn, mainly provides the steps of:
working out, at the level of local user-unit 2, a menu-verification request, which request is in the form of a data string as defined above;
transmitting the menu-verification request from the local user-unit 2 to the central distribution unit 3 according to the modes illustrated above;
comparing, at the level of central distribution unit 3, the menu version identified in the verification request with the latest version available, according to the procedure described above;
in case of difference between the compared menu versions, transmitting data for updating the menu from the central distribution unit 3 to the local user-unit 2 according to the modes illustrated above.

FIG. 5 schematizes an example of initialization procedure of the local unit 2 at time of power-on. In particular, at time of power-on (101) the wireless module, or any other alternative communication module, forwards the string data to the distribution unit 3, which compares the forwarded string to the most updated string by difference. The updating data (104), then, are sent to the decoder 4 having the series number contained in the string by means of a local server (103). Thus, the decoder 4, by using its own firmware, updates the menu (105) to be displayed for the viewer.

FIG. 6 schematizes an example of procedure for requesting a video from the local unit 2 to the distribution unit 3.

The user, typically a tele-viewer, chooses from the menu the programs to be displayed upon browsing among the static and dynamic menus (105). The decoder 4 prepares the request packet, containing the identifying programs with some series numbers and version numbers of the residing menus, and it forwards it, by means of the communication means 6, to the distribution unit 3, which processes the request by assigning the download (109) to a local server, to which the requesting decoder 4 is assigned, giving instructions about the necessary updatings (110). The downloading procedure is started towards the requesting decoder 4. The downloaded programs are filed (111) in the means 26 and they are made available for the display.

Of course, the presence of the wireless module or other modem in the network (for example in case of wired network) can allow to the central distribution unit or to the television company to interact with the local unit 2, and in particular with the processing and control means 20 thereof, providing to the same huge opportunities among which the deactivation of a certain local unit 2 or the updating of various program or firmware sections at the operator's choice. This implies the possibility of having personalized messages on the local unit 2, a kind of mail-box for service and even advertising messages.

It will be understood that the present invention is suitable for several embodiments alternative to the one described sofar.

In particular, both the communication means 6 of each local user-unit 2 and the communication module 8 of the central unit can base upon a communication network of DTT type (“Digital Terrestrial Television”), as shown in FIG. 1A.

At this point it will be better appreciated that the system and the method of the invention allow making easy and immediate the updating of local menus, improving the efficiency of the interactive TV.

The present invention has been sofar described by referring to preferred embodiments. It is to be meant that other embodiments belonging to the same inventive core may exist, all however comprised within the protective scope of the herebelow reported claims.

What is claimed is:

1. A video-on-demand system of the type comprising a plurality of local user-units and a central distribution unit apt to transmit videos to said local user-units, wherein each of said local user-units comprises:—means for storing a video menu;—means for selecting a video from said menu;—means for communicating with said central distribution unit, apt to send to the latter a request for transmission of the selected video and to receive such video; and—local updating means for updating said menu, apt to work out a menu-verification request for said central distribution unit and to send said request by means of said communication means, which request is in the form of a data string containing an identifier of the menu version stored at local level, and wherein said central distribution unit, in turn, comprises:—central updating means for updating the local menus, apt to send to each local user-unit, in reply to said menu-verification request, data for updating the local menu.

2. The system according to claim 1, wherein said data string worked out by said local updating means comprises a first portion containing said identifier of the menu version stored at local level and a second portion containing an identifier of the local user-unit.

3. The systems according to claim 2, wherein said second string portion contains an identifier of the firmware residing in the local user-unit.

4. The systems according to claims 1, wherein said communication means comprises a SIM card to send said menu-verification request to said central distribution unit.

5. The system according to claim 2, wherein said second string portion contains an identifier of said SIM card of the local user-unit.

6. The system according to claim 1, wherein each local user-unit comprises a decoder.

7. The system according to claim 2, wherein said second string portion contains an identifier of said decoder of the local user-unit.

8. The system according to claim 2, wherein said data string worked out by said local updating means comprises an additional portion containing an identifier of the related telephone use.

9. The system according to claim 1, wherein said communication means comprises a module of the wireless type to send said menu-verification request to said central distribution unit.

10. The system according to claim 1, wherein said wireless module is selected in a group comprising GSM, GPRS and UMTS modules.

11. The system according to claim 1, wherein said local updating means is apt to determine the sending of said menu-verification request to said central distribution unit automatically upon each activation of said local user-unit.

12. The system according to claim 1, wherein said communication means, in order to send said video request and to receive the video from said central distribution unit, bases upon a communication network of the digital terrestrial television (DTT) type.

13. The system according to claim 1, wherein said communication means of each local user-unit and said central distribution unit allow the transmission of videos in the streaming mode.

14. The system according to claim 1, wherein each local user-unit comprises means for storing and filing the videos received by means of said communication means.

15. The system according to claim 1, wherein said central distribution unit comprises means for inserting advertising in a video to be transmitted to local user-unit.

16. A managing method of a video-on-demand system of the type comprising a plurality of local user-units in communication with a central distribution unit apt to transmit videos to said local user-units so that each local user-unit allows to select a video from a video menu stored at local level, to send a request for transmitting the selected video to the central distribution unit and to receive the selected video, which method, in turn, comprises a procedure for updating the menu of each local user-unit which, in turn, provides the steps of: (i) working out, at the level of local user-unit, a menu-verification request, which request is in the form of a data string containing an identifier of the menu version stored at local level; (ii) transmitting the menu-verification request from the local user-unit to the central distribution unit; (iii) comparing, at the level of central distribution unit, the menu version identified in the verification request with the latest version available; (iv) in case of difference between the compared menu versions, transmitting data for updating the menu from the central distribution unit to the local user-unit.

17. The method according to claim 16, wherein said data string of said menu-verification request comprises a first portion containing said identifier of the version stored at local level and a second portion containing an identifier of the local user-unit.

18. The method according to claim 16, wherein said second string portion contains an identifier of the firmware residing in the local user-unit.

19. The method according to claim 16, wherein said step (ii) provides the use of a SIM card residing in the local user-unit.

20. The method according to claim 17, wherein said second string portion contains an identifier of the SIM card of the local user-unit.

21. The method according to claim 17, wherein said second string portion contains an identifier of a decoder of the local user-unit.

22. The method according to claim 17, wherein said data string comprises an additional portion containing an identifier of the related telephone use.

23. The method according to claim 16, wherein said step (ii) provides the use of a module of the wireless type to send said menu-verification request to said central distribution unit.

24. The method according to claim 16, wherein said step (ii) provides the use of a module of the wireless type selected in a group comprising GSM, GPRS, UMTS modules and modem.

25. The method according to claim 16, wherein said step (ii) provides the automatic dispatch of said menu-verification request to the central distribution unite upon each activation of the local user-unit.

26. The method according to claim 16, wherein said data for updating the menu of said step (iv) are processed by the local user-unit in the form of a file in the text format.

27. The method according to claim 16, wherein the video transmission from the central distribution unit to the local user-units bases upon a communication network of digital terrestrial television (DTT) type.

28. The method according to claim 16, wherein the video transmission from the central distribution unit to the local user-units takes place in the streaming mode.

29. The method according to claim 16, wherein each local user-unit allows storing and filing the received videos.

30. The method according to claim 16, wherein said video menu stored at local level comprises a frequent-updating menu portion and an occasional-updating menu portion.

31. The method according to claim 16, wherein said step (i), in turn, comprises a first step of analyzing the files on board a local decoder, a second step of coding the list of the present files, a third step of coding the amount of employed memory and of the memory available at local level and a fourth step of generating said data string.

32. The method according to claim 16, wherein said central distribution unit, before transmitting a video to a local user-unit, inserts advertising in the video to be transmitted.
